(19) United States
(12) Patent Application Publication
(10) Pub. No.: US 2004/0177159 A1
(43) Pub. Date: Sep. 9, 2004

(54) Systems for uploading and automatically processing computer files

(75) Inventors: Norman Ian Butterfield, West Vancouver (CA); Darren Inouye, Burnaby (CA); Yi Feng, Richmond (CA); Greg Bedford, Burnaby (CA); Paul Culling, North Vancouver (CA)

Correspondence Address: OYEN, WIGGS, GREEN & MUTALA, 480 - THE STATION, 601 WEST CORDOVA STREET, VANCOUVER, BC, V6B 1G1, CA

(73) Assignee: Webpost Enterprises Ltd., Vancouver (CA)

(21) Appl. No.: 10/377,787

(22) Filed: Mar. 4, 2003

(51) Int. Cl. G06F 15/16

(52) U.S. Cl. 709/246; 709/206

(57) ABSTRACT

A system for uploading files of different types to a server automatically performs actions on the files based upon the types of the files. An example application of the invention is a system for creating web pages which receives content for the web pages in the form of text in e-mail messages and/or file attachments to e-mail messages. The file attachments may be of any of a number of different types. File attachments of each type are automatically converted into components that may be incorporated into web pages. The components are automatically stored in a directory structure in folders based upon the file types and the identity of a user who forwarded the files to the system. Users can create web pages by inserting the components into web page templates and editing the templates. The web pages are automatically stored and made accessible to others.

### TECHNICAL FIELD

The invention relates to data communication networks. The invention relates in particular to the delivery of computer files of different types from one network-connected computer system to another. The invention has particular application to networks which include at least one server which hosts web pages. In this context the invention relates to methods for creating and managing web pages on the server as well as server apparatus useful for creating and managing web pages.

### BACKGROUND

There are various situations in which it is desirable to move computer files from one network-connected computer system to another. One example of such a situation is the creation and maintenance of web sites. Another example is archiving computer files on a remote computer. While there are numerous ways to transfer files between computers, most of these ways require users to use unfamiliar software and to know details such as the full path names of destination folders on the remote computer where each file should be stored.

One way to make information available on a computer network is to provide a web server connected to the network and to incorporate the information in one or more web pages. The server makes the web pages available to users on the network who request them. The requests are typically made by way of web browser software such as Microsoft Internet Explorer™ or Netscape Navigator™.

Each web page includes a set of HTML (Hypertext Markup Language) instructions which specify how information contained in the web page will be displayed by web browser software. To create a new web page a user must first generate the HTML instructions for the web page and then upload those instructions to an appropriately located and named file on the server which will host the web page. Neither of these steps is trivial.

A number of web authoring software packages are commercially available. These packages provide tools which make it simpler for users to create creating HTML web pages which are laid out in desired ways and provide mechanisms for desired interactions with users. Such packages are not always useful for casual users because they must be purchased and the users must learn about the software before they can use it effectively.

After a user has generated one or more web pages, the user must upload a file or files which contain the web pages to a server. This can be done using FTP (File Transfer Protocol) client software. However, the use of such software is not always straightforward. In order to use such software the user must know the location on the server in which the files should be stored and the path in which each file should be stored. Further, the user must negotiate whatever security authentication protocol has been implemented to prevent unauthorized web pages from being uploaded to the server.

There exist some web sites which include web-based tools for building rudimentary web pages. A user can navigate to those web sites using a browser and use the provided tools to create simple web pages. However, the tools provided by these sites are typically not as flexible as one would wish.

Carter et al., U.S. patent application publication No. US2002/0105545A1 discloses a hosted web portal. A user can upload information to the portal for display as a web page by sending an e-mail message containing the information to an e-mail address of the portal. The portal provides a single e-mail address for all users. The system uses the “From:” field of incoming e-mails to identify individual users. The Carter et al. system does not provide any flexibility for users as it creates web pages by parsing incoming e-mail messages and adding HTML tags to the text of the e-mail messages in a predetermined way. The Carter et al. system also has very limited capabilities for dealing with attached files such as images.

There is a need for easy to use systems which permit a computer user to upload files of various types to appropriate locations on a remote computer system. There is a particular need for such systems in the context of web page creation tools. Such a system can help to make web page creation intuitive and yet provide users with sufficient flexibility to create and maintain web pages. In the field of web page creation tools it is desirable to provide tools which permit users to post documents in formats viewable by various types of devices.

### SUMMARY OF THE INVENTION

This invention provides a system for making content of various types available on a web server. The system may, for example, handle text, image files of one or more different formats, word processing files of one or more different formats, spreadsheet files of one or more different formats and/or page description files of one or more formats. The system includes an e-mail interface which permits users to upload files to the system by sending e-mail messages with file attachments. The system automatically processes the attachments and makes them available for incorporation into web pages.

One aspect of the invention provides a method comprising determining a file type of an attachment to an electronic mail message; identifying, from among a plurality of different predefined actions associated with respective file types, at least one predefined action associated with the file type of the attachment to the electronic mail message; and, performing the at least one predefined action in relation to the attachment.

Further aspects of the invention and features of specific embodiments of the invention are described below.

### BRIEF DESCRIPTION OF THE DRAWINGS

In drawings which illustrate non-limiting embodiments of the invention,

FIG. 1 is a network diagram illustrating a basic configuration for a system according to the invention;

FIG. 2 is a flow chart illustrating a basic method of the invention;

FIG. 2A is a flow chart which illustrates a method for posting documents to a web site according to the invention;

FIG. 3A is a timing diagram illustrating the relative timing of exchanged e-mail messages in a method as shown in FIG. 2; FIG. 3B is a timing diagram illustrating the relative timing of exchanged e-mail messages in a method according to an alternative embodiment of the invention;

FIG. 4 is an example of a directory structure which may be provided at a server for storing user-supplied files;

FIG. 5 is an example of a graphical user interface by way of which a user can create a web page according to the methods of the invention;

FIG. 6 is a flow chart showing a more detailed view of a possible method for creating a web page according to the invention;

FIG. 7 is a block diagram illustrating functional aspects of a system according to the invention; and,

FIG. 8 is a network diagram illustrating one way to distribute the functions of a system according to the invention between several computers.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

In broad terms, some currently preferred embodiments of this invention provide systems which permit users to upload files of different types to a server as attachments to e-mail messages (also called “electronic mail” messages). The attachments are automatically processed, in different ways, by performing predetermined actions on the files based upon their types.

In some embodiments of the invention the attachments are automatically processed, in ways which vary with their types, to generate corresponding files. The corresponding files may, for example, comprise files suitable for incorporation into web pages. The corresponding files may be automatically stored in the directories of the directory structure. Text from the body of the e-mail message may also be automatically stored within a directory of the directory structure.

The actions performed on the files may comprise other actions such as:

Translating text within the files into different languages depending upon the file type and/or source;

Converting to a different file format depending upon the file type and/or source;

Parsing data from the files in ways determined by the file type and/or source; or,

Saving data from the files in a database in fields which depend upon the file type and/or source.

The invention is described below using the example embodiment of a system for making content available on a web server. However, the invention is not limited to this context. The invention can be broadly applied in any context wherein it is desirable to provide files of different types to a remote computer system and have the remote computer system perform different actions on the files based upon their types and source. In some embodiments of the invention the different actions may comprise storing the files in different locations in a directory structure maintained by the remote computer system.

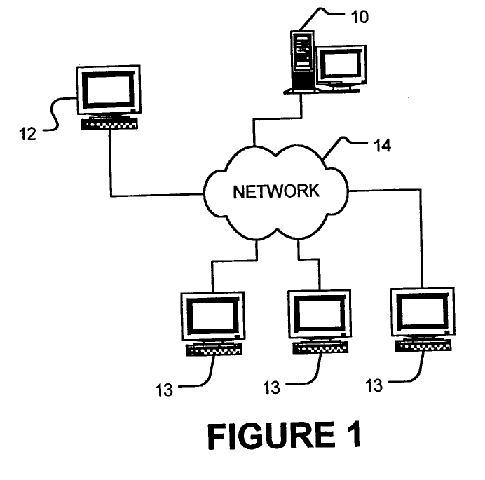

FIG. 1 is a block diagram which illustrates one context in which a system according to the invention may be used. The system includes a server 10 which can communicate with a first user computer 12 and a number of additional user computers 13 by way of a data communication network 14. Network 14 may comprise a global computer network such as the internet or a network of smaller scope.

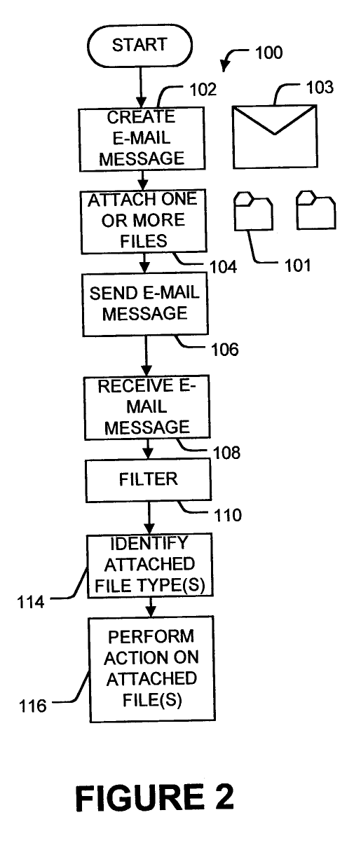

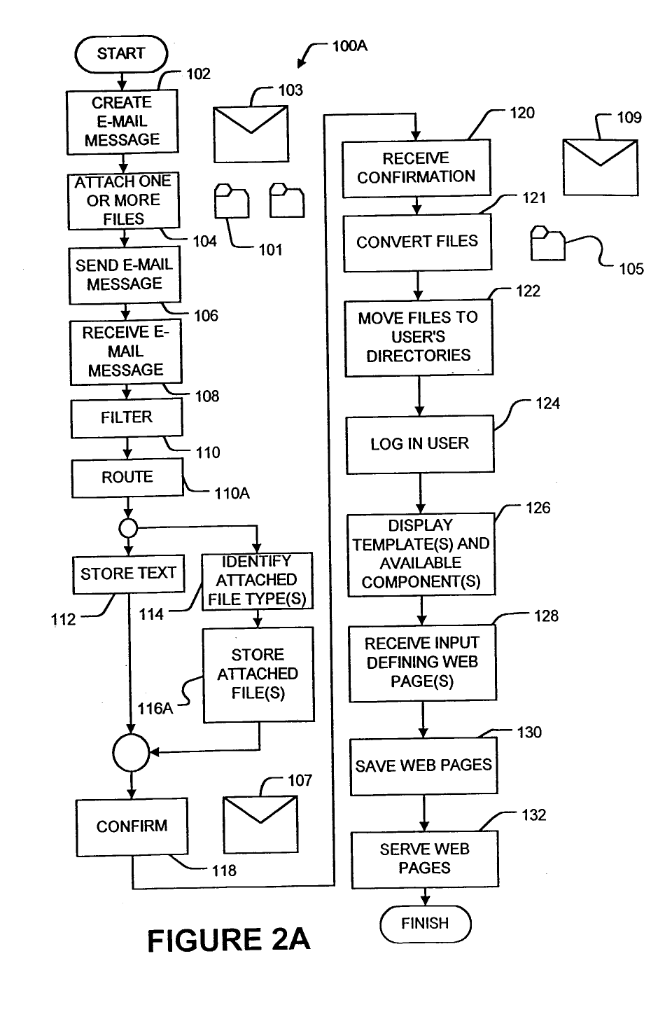

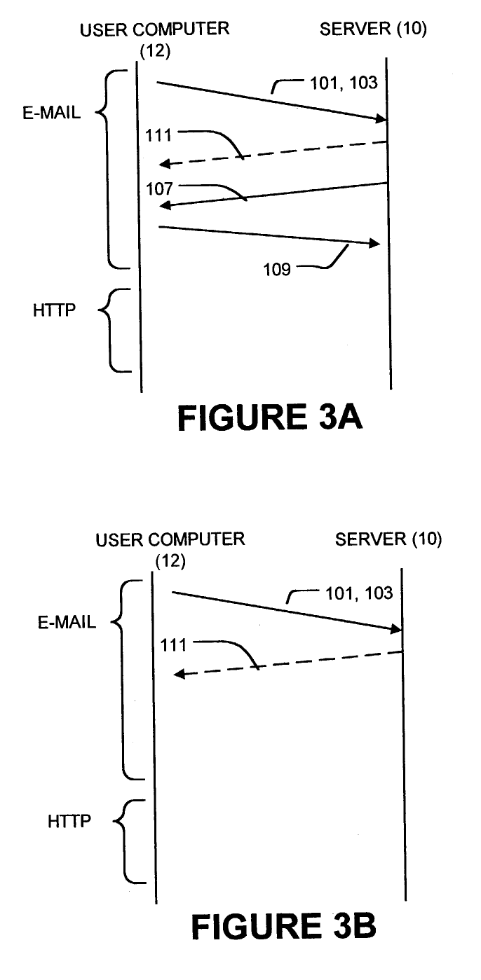

FIG. 2 is a flowchart which provides an overview of a method 100 according to one embodiment of the invention. The upper portion of FIG. 3A shows a time line illustrating the sequence in which e-mail messages are exchanged between a user computer 12 and server 10 during the performance of method 100.

Method 100 may be used, for example, by a user who wishes to post some electronic documents 101 on a web site hosted by server 10 so that they can be viewed by users at additional user computers 13. Electronic documents 101 are stored on a storage device accessible to first user computer 12. Documents 101 may be of one or more different types. For example, documents 101 may comprise any reasonable number of text files, image files of one or more formats (such as, for example, TIFF files, GIF files, JPEG files), word processing files of one or more formats (such as, for example, Microsoft Word™, or WordPerfect™ files), spreadsheet files of one or more different formats (such as, for example, Microsoft Excel™ or Corel Quattro Pro™), or page description files (such as, for example, Adobe™ pdf or Postscript files). Documents 101 may also comprise files of other types such as video files, animation files, sound files, or other files containing content which can be handled by server 10.

In block 102, using any suitable e-mail client software such as Microsoft Outlook™, Eudora™, Pegasus™ or the like, the user creates an e-mail message 103. In block 104 the user attaches the files containing documents 101 to message 103. In block 106 the user addresses message 103 to a predetermined e-mail address (if this has not been done already) and sends message 103 together with its attached files. All this can be done using any suitable e-mail client. The user needs to have no more information than the predetermined e-mail address to which e-mail message 103 is to be sent.

The predetermined e-mail address may be specific to the user. For example, if the server is associated with the domain name “webpost.com” then the predetermined e-mail address may be of the form “user@webpost.com” where “user” is a character string which is unique to the user. In such embodiments of the invention a distinct e-mail address is provided for each user.

In block 108, server 10 receives e-mail message 103 together with the attached file or files which make up documents 101. Server 10 optionally filters the e-mail messages that it receives in block 110. Block 110 may include one or more checks which check various things about e-mail messages 103 including things such as:

Is the e-mail message from a sender who is authorized to use the facilities of server 10?;

Are documents 101 of types which are recognized by server 10?;

Are documents 101 of types which can be handled by server 10?;

does the e-mail include an appropriate password, if required;?

If the checks are all passed successfully then processing continues. If one or more of the checks fails then various actions may be taken. For example, the e-mail message may be deleted and a reply 111 (FIG. 3A) may optionally be sent automatically. Reply 111 may indicate that the message was not accepted by server 10.

Server 10 may receive e-mail messages having different functions. For example, server 10 may receive some e-mail messages 103 which include documents 101 to be processed by server 10 and other e-mail messages 109 which relate to control functions such as authorization to proceed to process certain attachments (as described below). If so then method 100A may comprise a routing step 110A which determines the functions of e-mail messages which have passed filter 110 (if present) and passes those e-mail messages to appropriate parts within server 10.

In block 114 the file types of any documents 101 are determined. The file types may be determined from the names of any documents 101. If the file names include extensions then the file type may be inferred from the extension. For example, files having names ending in “.doc” may be identified as Microsoft WORD™ files, files having names ending in “.jpg” may be identified as JPEG image files, and files having names ending in “.pdf” may be identified as ADOBE Postscript™ files. Additionally or in the alternative, block 114 may determine the types of documents 101 by inspecting file attributes and/or by inspecting the structures of documents 101.

In block 116 one or more action(s) are performed on documents 101. The action performed on each attached document 101 is determined based upon the type of the document 101 as determined in block 114. The action may also be determined on the basis of the source of the document 101. The actions may be any of a wide range of possible actions.

It can be appreciated that method 100 can be used in many contexts. The only information that a user needs to have is the e-mail address to which an e-mail message containing documents 101 should be sent. The specific actions performed in relation to documents 101 will depend upon the context in which method 100 is being applied.

FIG. 2A, shows a method 100A which uses method 100 to upload files to a web server so that the information in the files may be published in web pages. In method 100A the actions performed on documents 101 involve storing the files in directories determined by the file types and the source of the files and using conversion routines determined by the types of documents 101 to prepare one or more components 105 based upon each of documents 101 for possible incorporation into web pages.

Method 100A begins as with method 100. After e-mail message 103 has been received, method 100A stores the text of e-mail message 103 in block 112 for possible later use. The resulting text file may be assigned a file name which allows the user to identify it. For example, the file name may be automatically constructed by server 10 from the subject line of the e-mail, the date and time or both the subject line and the date and time of upload.

In block 112 any text in e-mail message 103 may be stored in a temporary directory for later use, as described below. In block 114, the file types of documents 101 attached to e-mail message 103 are identified. In block 116 actions are performed on documents 101. The specific action performed on each document 101 is determined by server 10 based upon the file type of the file or on the file type of the document 101 and its source.

The file type of a document 101 may be determined by a file extension or by other attributes of the document. The source of the document is preferably determined from the e-mail address to which the e-mail 103 carrying the document 101 was sent (i.e. from the contents of the “TO:” field of e-mail 103). This has the advantage that a user can upload content to server 10 using any e-mail account. In the alternative, the source of the document could be determined by the “from” field of e-mail message 103, by a password supplied with e-mail message 103 or in some other manner that identifies the source of e-mail message 103.

Method 100A may store documents 101 in a set of temporary directories for later possible use in block 116A. In one embodiment of the invention, documents 101 are each stored in a subfolder within a folder. The identity of the folder is determined by the source of e-mail 103. The sub-folder in which each document 101 is stored is selected according to the file type for that document 101, as identified in block 114. Documents 101 may be stored under their previously-assigned file names or method 100A may assign new names to documents 101.

In a preferred embodiment of the invention, server 10 automatically scans the names of documents 101 for the presence of any characters or groups of characters which are not permitted in file names on server 10 and replaces those characters or groups of characters with acceptable characters. Server 10 may also automatically alter the names assigned to documents 101 to avoid duplicate file names within the same folder on server 10.

In block 118, server 10 sends to the user an e-mail message 107 which confirms that documents 101 have been received and are available on server 10. Optionally, server 10 may wait (in block 120) to receive from the user a reply 109 to e-mail message 107 before proceeding. In block 118, server 10 may insert a password, which may comprise a random number or a randomized set of characters, into e-mail message 107. In block 120 server 10 may check for the presence of the same password in e-mail message 109. If the password is not received in block 120 within a reasonable time then server 10 may discard documents 101.

After receiving confirmation 109 from the user, if necessary, server 10 automatically selects a file conversion routine based upon the file type of each document 101 and then automatically runs the conversion routine against the document 101 to generate a component 105 that corresponds to the document and can be incorporated into a web page (block 121). The appropriate conversion routine is automatically selected based upon the file type of each of documents 101 and applied to each of documents 101 to yield one or more components 105 corresponding to each document 101.

The conversion routine may, for example, generate for each document 101 an image file in each of one or more resolutions. By way of example, the conversion routine may generate for each document 101 a thumbnail image; an 800×600 pixel image; one or more images having size(s) chosen to fit into standard templates in use on system 10; and/or images having sizes suitable for display on displays of one or more types of portable device. Portable devices such as WAP-enabled cellular telephones typically display images having a coarser resolution than standard web browsers. In the alternative, for “text”-based file types such as word processor files, spreadsheets or Adobe™.pdf files the conversion routine may generate one or more of a plain text file, a markup language file such as a HTML file or an XML file or the like.

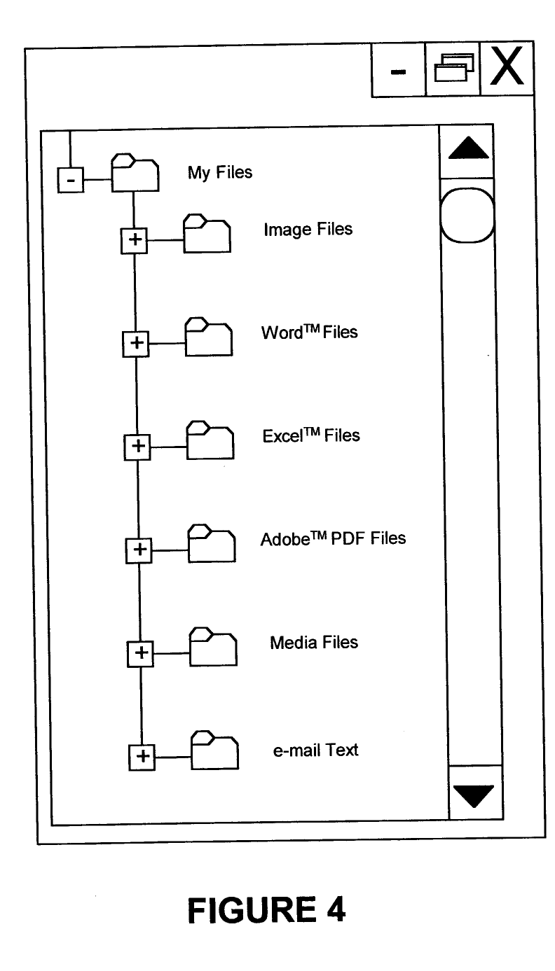

In block 122, server 10 automatically places copies of documents 101 and components 105 in a long term directory structure associated with the user (block 122). For example, each user may have a corresponding set of directories on a file system accessible to server 10. A separate directory may be provided for each type of files recognized by server 10. FIG. 4 is a view of a possible directory tree 120 containing directories 122 in which components 105 documents 101 may be stored. A similar directory tree may be provided for each of a number of users.

Server 10 may save information about each stored file such as its size, date of upload, type, number of pages if it is a multi-page document, and dimensions, if the file contains an image, in database 30.

In block 124 server 10 permits the user to log on in a web session. When the user has logged on, server 10 presents the user with a web-based interface by way of which the user can access one or more web page templates and any files stored in the user's set of directories (block 126). After a user selects a template then the user can use the template in block 128 to define a web page. For example, the user can add content to the template at least by selecting one or more components 105 from the user's set of directories for inclusion in the web page. In preferred embodiments of the invention the user can add content to a template by dragging and dropping an icon representing a component 105 onto a location on a graphical representation of the template.

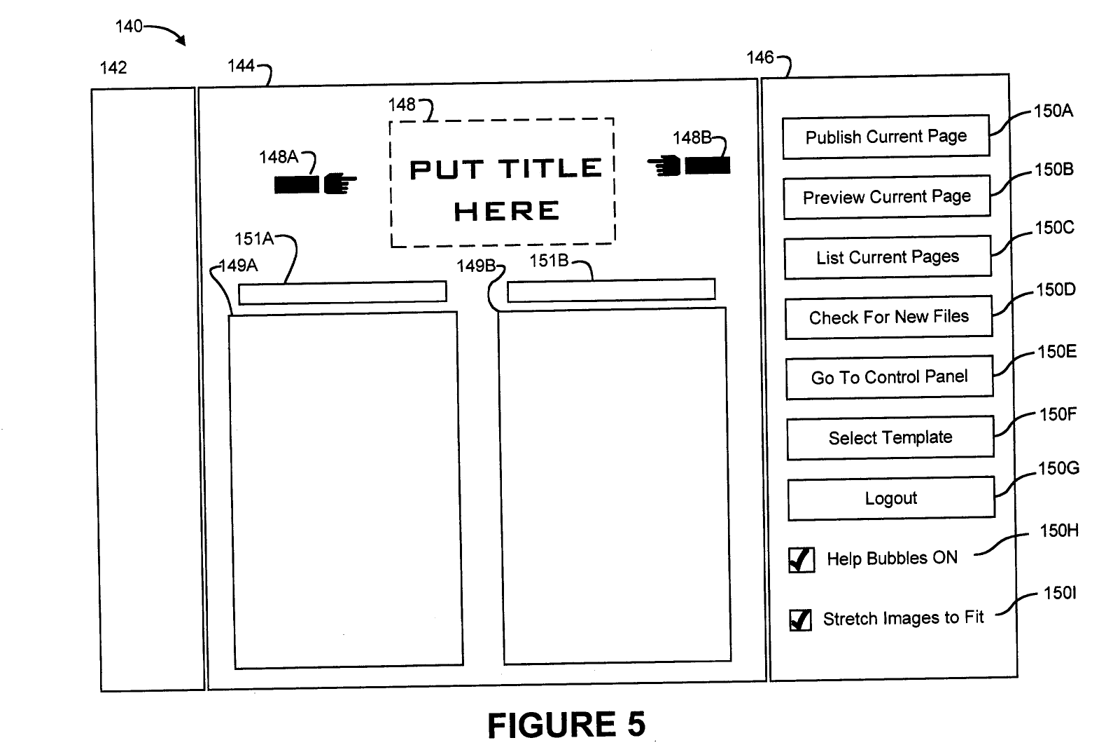

FIG. 5 shows an example of a possible user interface 140 that server 10 could present to a user. Interface 140 comprises a file management window 142 which displays components 105 available to the user. File management window 142 may, for example, include a graphical file tree similar to that shown in FIG. 4. The user may use file management window 142 to select components 105 for inclusion in a web page. Interface 140 also comprises a template window 144 which displays a selected template and a control window 146.

In the illustrated embodiment, template window 144 is displaying a two-window template having a title area 148, and windows 149A and 149B (collectively windows 149). Each window 149 can receive a component 105. A user can drag a selected component 105 from file management window 142 and drop it onto one of windows 149 to cause the window 149 to display the selected component 105. The template shown in template window 144 also includes hyperlinks 151A and 151B. Server 10 automatically links hyperlinks 151A and 151B to the stored original documents 101 associated with the components 105 which have been associated with the corresponding window 149. After the web page has been posted on server 10 a user who accesses the web page can download an original document 101 by activating a corresponding link 151.

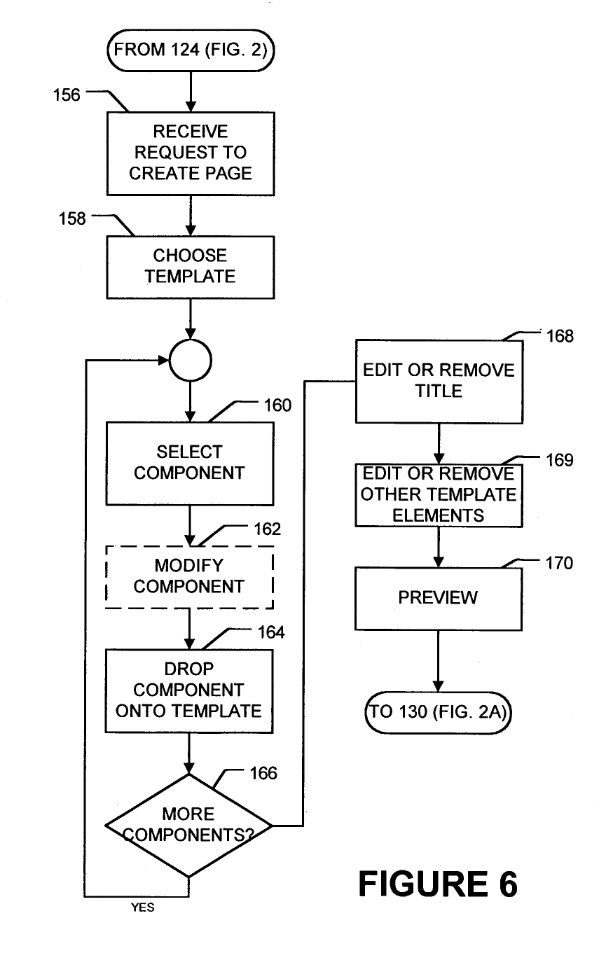

A user can operate controls 150 in command window 148 to control the operation of server 10. In the example embodiment shown in FIG. 6 controls 150 have the functions shown in Table I.

TABLE I
Control Functions for Interface 140 of Figure 6

| Control Reference | |
|---|---|
| Numeral | Function |
| 150A | Causes server 10 to publish the current page. |
| 150B | Causes server 10 to display a preview which |
| | shows what the current page would look like |
| | when viewed. |
| 150C | Causes server 10 to display a list of web pages |
| | which have been previously published by the |
| | user. |
| 150D | Causes server 10 to update file manager window |
| | 142. |
| 150 | Causes server 10 to display a control panel which |
| | the user can use to configure system 10 according |
| | to the user's preferences. |
| 150F | Causes server 10 to display a list of available web |
| | page templates from which the user can choose. |
| 150G | Causes server 10 to log the user out of the HTTP |
| | session. |
| 150H | Causes server 10 to turn help bubbles on or off. |
| | When help bubbles are “on” a help window |
| | which displays context-sensitive help is displayed |
| | whenever the user leaves the cursor positioned |
| | over a part of interface 140 for more than a |
| | predetermined time. |
| 150I | Causes server 10 to automatically stretch or |
| | shrink the image of a component 105 by an |
| | amount necessary to make the image of the |
| | component fit into a particular window 149. |

FIG. 6 illustrates in more detail a possible implementation of blocks 126 and 128. In block 156 server 10 receives a request to create a new web page (for example by the user activating control 150F of FIG. 5). In block 158 server 10 allows the user to select a template from a plurality of available templates. System 10 displays the selected template and then permits the user to create a web page by adding the user's components 105 to the web page and/or editing editable parts of the web page.

In block 160 a user selects a component 105 (for example on clicking on an icon representing the component 105 in file management window 142. Server 10 may be configured to permit the user to optionally modify a selected component 105 in block 162 and to save the modifications (either by overwriting the existing component or by saving an edited version of the component under a new name. For example, the user may cause the image of the component to be resized or rotated or the user may add a caption to the image of the component. In block 164, server 10 associates a component 105 with a location of the selected template. Blocks 160 through 164 may be repeated for up to as many components 105 as can be accommodated by the currently selected template.

The user can then complete the web page by editing or removing the title (if the template provides a title) in block 168 and editing or removing other template elements such as decorations 148A and 148B (if the template provides other elements) in block 169. In block 170 the user can preview the appearance of the completed web page (for example by activating control 150B).

After a user has defined a web page, server 10 saves the web page in a location accessible to server 10 and assigns a name to the web page (block 130). The name may be user-selected. The web page is then accessible to users at user computers 13. In preferred embodiments of the invention the web page is also accessible to users of other web-enabled devices such as web-enabled cell phones or PDAs.

As is known to those skilled in the art, a web page created by system 10 may use scripts to select content to send to web browsers which attempt to access the web page. For example if the script detects that a particular type of mobile device is requesting access to the web page then the script might direct the request to an asp file appropriate for that mobile device. If the script detects that a standard web browser is requesting access to the web page then the script might direct the request to an asp file appropriate for that web browser. Server 10 may automatically prepare web pages suitable for various different devices.

The address or URL which can be used to retrieve web pages created according to the method of the invention may be assigned according to any of various schemes. In one scheme, a web server component of server 10 has a general URL such as “www.webpost.com”. Each user has a general URL. Web pages created by a user are placed under the user's general URL and are identified by names assigned by a user. For example, web pages for a user having the username “abcd” might be automatically stored in a folder accessible by the URL “www.webpost.com/abcd/”. If user abcd creates a web page and names that web page “flowers” then the web page would be accessible under the URL “www.webpost.com/abcd/flowers”.

The system may have different hierarchies or groups of users. For example, a company might have a number of users who all post web pages on a system according to the invention. Web pages created by users associated with the company may all be accessible under a URL general to the company. For example, suppose a user abcd is an employee of a company who has a user name XYZ on the system. The system may automatically store web pages created by the user in a folder accessible under the URL “www.webpost.com/XYZ/abcd/”.

In preferred embodiments of the invention, server 10 automatically saves two versions of the web page. A first HTML version to be accessed by network-connected user computers 13 as described above. A second XML version, which uses smaller versions of each component 105 can be accessed by wireless devices.

Many variations and modifications may be made to this method without departing from the broad scope of the invention. For example:

Any suitable schemes may be made to identify and authenticate incoming e-mail messages and users to server 10. For example, FIG. 3B illustrates an alternative embodiment of the invention wherein users include passwords in e-mail messages 103. The passwords may be provided in the Subject fields of messages 103. This embodiment of the invention avoids the exchange of messages 107 and 109.;

The order in which operations may be varied. For example, the method 100A described above waits for confirmation in block 120 before generating components 105 in block 121. Components 105 could be generated automatically as part of block 116A. This has the disadvantage that the computational resources involved in generating components 105 would be wasted if confirmation is not received in block 120.

The details of the user interface by way of which users can select templates, select components 105 and build web pages are not important to the invention. Any suitable interface may be provided.

### EXAMPLE

As a very simple example of a method according to the invention, suppose a user has stored on user computer 12 a number of digital photographs stored in a TIFF (Tagged Image File Format) format and a Microsoft Word™ file which contains text describing the photographs. The user has an account on server 10 in which the user is identified by the user name “abcd”. The user has obtained the account in any suitable manner, for example by filling out an on-line form requesting that an account be opened.

The user prepares an e-mail message addressed to abcd@webpost.com using the user's regular e-mail client. The user attaches the digital files for the photographs and Word file to the e-mail message 103 and sends the e-mail message. Server 10 receives the e-mail message and converts each of the image files to a component 105 using a conversion routine suitable for TIFF files. Server 10 also converts the Word file to a component 105 using a conversion routine suitable for Microsoft Word files. The user then logs into server 10 using any suitable web browser software and selects a web page template which provides places for a number of images and some descriptive text. The user accesses the user's directories on server 10, sequentially selects each of the components 105 corresponding to an image file and drops them onto the selected template to fill image places. The user selects the component corresponding to the Word file and drops it on the template in the place for the descriptive text. The user then causes server 10 to save the filled template as both an HTML web page and an XML page. Other internet users can then view the web page.

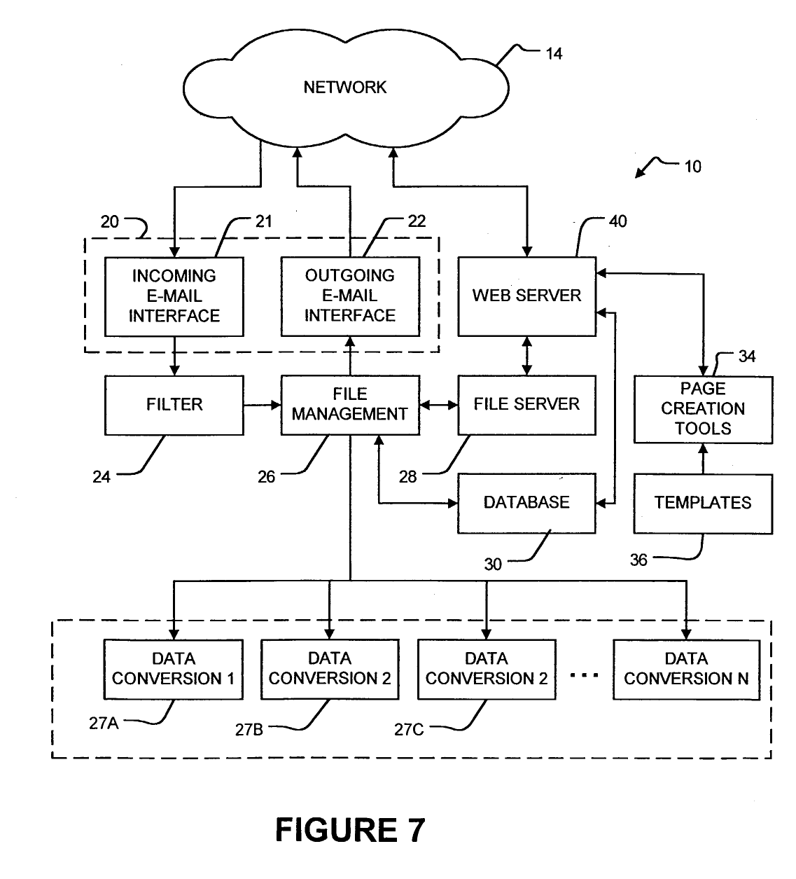

As shown in FIG. 7, server 10 constitutes apparatus which can be logically broken down into a number of functional components. These components are typically provided by software processes running on a computer system. The computer system may comprise a single processor or may comprise multiple processors. The functional components of the computer system may be present in a single computer or may be distributed among a number of separate computers.

Server 10 comprises an e-mail system 20 which comprises an incoming e-mail interface 21 and an outgoing e-mail interface 22. Server 10 can receive e-mail messages which arrive via network 14 addressed to e-mail addresses of server 10. Outgoing e-mail interface 22 sends e-mail messages which originate at server 10.

Server 10 optionally includes a filter system 24 which scans incoming e-mail messages and their attachments. Filter system 24 rejects incoming e-mail messages which fail to satisfy one or more filtering criteria. For example, filter system 24 may scan incoming email messages and any e-mail messages which satisfy one or more of the following criteria:

The message contains attached files of unknown types;

The message contains an attached file which appears to be corrupted;

The message contains an attached file which is over an acceptable size; or,

The message does not originate from an authorized sender.

If an e-mail message is rejected then filter 24 may cause a reply outgoing e-mail message 111 to be generated and sent via outgoing e-mail interface 22. The outgoing e-mail message may include a statement that the e-mail message was rejected and may contain an explanation as to why the e-mail message was rejected.

The contents of e-mail messages that are accepted by filter system 24 are forwarded to file management system 26. File management system 26 uses data conversion system 27 to convert the text of a received e-mail message into a component 105 and to convert any files attached to the e-mail message into components 105. Data conversion system 27 may comprise separate data converters 27A, 27B, 27C, . . . for each of a plurality of different file types. File management system 26 automatically stores components 105 in a directory structure in a file server 28 and enters information about the received e-mail in a database 30.

File management system 26 may also perform authentication of incoming e-mail messages. For example, file management system 26 may check a password in received e-mail messages against database 30 before making any components 105 which originated with that e-mail message available for use. File management system 26 may also, or in the alternative, perform more comprehensive authentication checks. In one embodiment of the invention, file management system 26 initially causes file server 28 to store components 105 and/or the original files received in an e-mail message in a temporary folder. Upon completing whatever authentication procedure file management system 26 is configured to carry out, file management system 26 causes file server 28 to move components 105 to a directory available to page creation tools 34.

Server 10 comprises a web server 40 which permits users who have web browsers to access web pages stored in file server 28. Web server 40 also permits users who have web browsers to access page creation tools 34 and to create new web pages using components 105 that have been previously stored on file server 28. Page creation tools 34 may permit users to create a web page based upon a template selected from among a number of templates 36.

The functional elements shown in FIG. 7 may comprise software processes running on one or more computers. For example, mail system 20 may comprise e-mail server software such as SENDMAIL™ server software, EUDORA™ Internet Mail Server or the like. Any suitable software including the large number of commercially available e-mail server systems may be used to provide mail system 20. Similarly, web server 40 may comprise any suitable web server software. Web server 40 may comprise commercially available software such as Microsoft™ IIS (Internet Information Server), Apache™ Server or the like. File management 26 may comprise software processes generated in any suitable programming environment which include program logic which causes server 10 to operate according to the invention. File management 26 includes suitable interfaces to the other components of server 10. File server 28 may comprise any suitable file server software including commercially available software such as Netware™, Microsoft Windows 2000 Server or the like. Database 30 may comprise any suitable database software including commercially available software such as Oracle™, Microsoft Access™, IBM DB2™, or the like.

As will be understood to those skilled in the art there are a great many ways in which a system according to the invention may be constructed. In providing a system according to the invention, a person skilled in the art will take into consideration factors such as the expected number of users, the number and size of web pages to be hosted, the expected number of requests to view those web pages. The person can then apply computer system design skills in a routine and non-inventive manner to configure a system according to the invention.

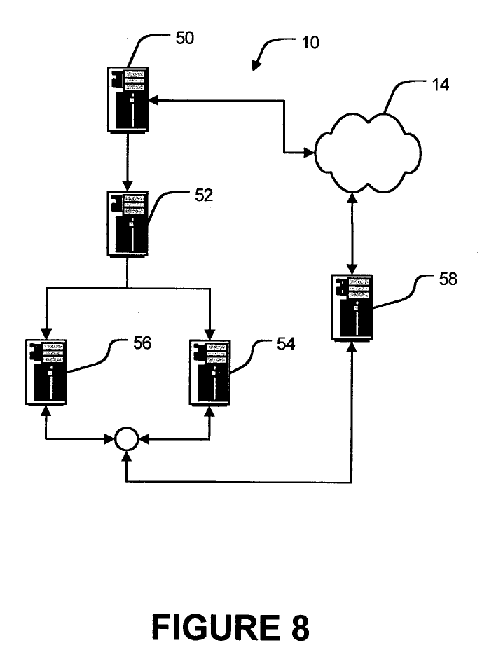

The functions of server 10 may be provided within a single computer system or may be distributed among a number of distinct computer systems. Each of the computer systems may include one, two or more data processors. As but one example of a way in which the functions of server 10 may be divided between a number of computer systems, FIG. 8 shows a system according to the invention in which server 10 comprises software processes running on 5 networked computer systems. In the embodiment of FIG. 8, e-mail software and initial filtering software are hosted on a first computer 50. File management and data conversion functions are provided by software running on a second computer 52. Computer 54 provides file storage and acts as a file server for server 10. Computer 56 runs database server software and acts as a database server for server 10. Computer 58 runs web server software.

Certain implementations of the invention comprise computer processors which execute software instructions which cause the processors to perform a method of the invention. For example, one or more processors in a computer system comprising one or more computers may implement the methods of FIGS. 2 and 6 by executing software instructions in a program memory accessible to the processors. The invention may also be provided in the form of a program product. The program product may comprise any medium which carries a set of computer-readable signals comprising instructions which, when executed by a computer processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example:

Web pages generated by the methods of this invention do not need to be hosted on a web server which is in the same geographic location as the server running the software which permits the web pages to be created. The system may automatically send web pages created by users of the system to directories on one or more remotely located web servers.

Users can be authenticated to server 10 in any suitable way. For example, authorized users may be required to send a password or key together with their e-mail messages to server 10. Server 10 can check the password or key to determine whether or not the e-mail is from an authorized user. In the alternative, server 10 may seek confirmation from authorized users by requiring the users to reply to e-mail messages sent to an e-mail address stored in server 10. Any other suitable authentication system may also be used. In some cases, for example where the invention is being used to permit employees of a company to post web pages which are only available within the company authentication of users may not be required.

Accordingly, the scope of the invention is to be construed in accordance with the substance defined by the following claims.

What is claimed is:

1. A method comprising:
determining a file type of an attachment to an electronic mail message;
identifying, from among a plurality of different predefined actions associated with respective file types, at least one predefined action associated with the file type of the attachment to the electronic mail message; and,
performing the at least one predefined action in relation to the attachment.

2. A method according to claim 1 wherein performing the at least one predefined action comprises placing the attachment in a directory associated with the file type.

3. A method according to claim 2 wherein the directory is also associated with a source of the electronic mail message.

4. A method according to claim 3 comprising reading contents of a “to:” field of the electronic mail message and determining the source of the electronic mail message from the contents of the “to:” field.

5. A method according to claim 3 comprising reading a password from the electronic mail message and determining the source of the electronic mail message from the password.

6. A method according to claim 3 comprising reading contents of a “from:” field of the electronic mail message and determining the source of the electronic mail message from the contents of the “from:” field.

7. A method according to claim 2 wherein placing further comprises renaming the attachment if a filename of the attachment matches a filename of any other file in the directory.

8. A method according to claim 1 wherein performing the at least one predefined action comprises using a conversion algorithm associated with the file type to convert the attachment from the file type to a different desired file type.

9. A method according to claim 8 comprising converting the attachment from the file type to a plurality of different desired file types.

10. A method according to claim 9 wherein at least one of the plurality of different file types is a file type receivable by a browser in a remote communications device.

11. A method according to claim 8 wherein converting comprises converting the attachment to a browser-accessible file type.

12. A method according to claim 8 wherein converting comprising converting the attachment to a markup language document.

13. A method according to claim 12 wherein converting comprises converting the attachment to a hypertext markup language (“HTML”) document.

14. A method according to claim 12 wherein converting comprises converting the attachment to an extended markup language (“XML”) document.

15. A method according to claim 8 wherein converting comprises converting the attachment from a word processing file type to the desired file type.

16. A method according to claim 8 wherein converting comprises converting the attachment from a spreadsheet file type to the desired file type.

17. A method according to claim 8 wherein converting comprises converting the attachment from a document image file type to the desired file type.

18. A method according to claim 1 further comprising identifying and automatically replacing illegal characters in a filename of the attachment.

19. A method according to claim 1 wherein performing the at least one predefined action comprises translating text within the attachment from one language into another language.

20. A method according to claim 1 wherein performing the at least one predefined action comprises saving data from the attachment in a database.

21. A method according to claim 20 wherein saving the data in the database comprises saving the data in fields determined by the file type of the attachment, the source of the attachment or both the file type and source of the attachment.

22. A method according to claim 1 further comprising associating each of a plurality of predefined actions with a corresponding one of a plurality of file types.

23. A method according to claim 22 comprising receiving one or more electronic mail messages all from the same source, the one or more electronic mail messages comprising a plurality of attachments of different file types wherein the predefined actions comprise automatically sorting the attachments into directories of a plurality of directories, each of the directories associated with a corresponding one of the file types.

24. A method according to claim 22 comprising:
identifying and automatically replacing illegal characters in filenames of the attachments;
storing text of the one or more electronic mail messages;
identifying respective file types of the attachments;
automatically renaming any attachment having a filename matching that of a file already present in the directory into which the attachment is being placed; and,
automatically converting at least some of the attachments to a desired file type, wherein the automatically converting comprises automatically converting at least one of the attachments from a file type selected from the group consisting of: word processing files, spreadsheet files, page description files and image files, to a markup language document.

25. A method according to claim 24 wherein the automatically converting comprises automatically converting attachments from at least two different file types selected from the group consisting of: word processing files, spreadsheet files, page description files and image files, to markup language documents.

26. A method according to claim 1 comprising receiving the electronic mail message including a plurality of attachments of a plurality of different types wherein performing the predefined action comprises using algorithms specific to each of the predetermined types to generate from the plurality of attachments a plurality of components having a common type.

27. A method according to claim 26 wherein each of the components comprises a file capable of being incorporated into a web page.
